(19) United States
(12) Patent Application Publication
(10) Pub. No.: US 2007/0236334 A1
(43) Pub. Date: Oct. 11, 2007

(54) Enhancing face-to-face communication

(76) Inventors: Richard D. Borovoy, Boston, MA (US); Steven R. Baturin, Norwood, MA (US); Steven R. Beckhardt, Boston, MA (US); Daniel J. Feldman, Brookline, MA (US); Timothy M. Gorton, Somerville, MA (US); Sergei Makar-Limanov, Belmont, MA (US); Richard A. Aparo, Newton, MA (US); Adam Casey, Whitman, MA (US); Brandon Eash, Brookline, MA (US); Stuart D. Perry, Wellesley, MA (US)

Correspondence Address: FISH & RICHARDSON PC, P.O. BOX 1022, MINNEAPOLIS, MN, 55440-1022, US

(21) Appl. No.: 11/397,032

(22) Filed: Mar. 31, 2006

(51) Int. Cl. H04Q 5/22

(52) U.S. Cl. 340/10.2; 340/10.1; 340/572.1; 340/825.49

(57) ABSTRACT

A mobile wireless device has a device identifier, is located in a meeting venue, and communicates with a server through one or more wireless access points associated with the meeting venue. The device receives, from one of the access points, access point information that identifies the access point, and sends information including the device identifier to the access point.

### BACKGROUND

This description relates to enhancing face-to-face communication.

Several years ago, nTAG Interactive Corporation developed an interactive tag to be worn around the neck of an attendee at a convention. This tag is able to electronically communicate with tags worn by other attendees, for example, when the attendees face each other. The tags (also sometimes called badges) can exchange data electronically even before the two attendees have a chance to talk to each other. The data can carry information about what the two attendees have in common. The tags also can communicate wirelessly with readers, such as RFID readers or WiFi or WiMax transceivers. These tags are described in U.S. patent application Ser. No. 10/396,064, filed Mar. 24, 2003, and Ser. No. 10/729,696, filed Dec. 5, 2003, both entitled Apparatus and Method for Enhancing Face-to-Face Communication, incorporated here by reference. They are also described in U.S. patent application Ser. No. 11/069,716, filed Feb. 28, 2005, entitled Method of Scoring the Performance of Attendees at a Meeting, also incorporated here by reference.

### SUMMARY

In general, in one aspect, a mobile wireless device has a device identifier, is located in a meeting venue, and communicates with a server through one or more wireless access points associated with the meeting venue. The device receives, from one of the access points, access point information that identifies the access point, and sends information including the device identifier to the access point.

Implementations may include one or more of the following features. Deactivating the device at times when it is not doing the receiving or sending. Receiving, from another one of the access points, access point information that identifies the other access point, and determining with which of the two access points the communication is stronger, and sending the access point information of the access point with which the communication is stronger. Sending updated access point information as the identity of the access point with which communication is stronger changes. Receiving a synchronization signal from one of the access points. At a time assigned to another device, monitoring for a transmission from that device. If the transmission is detected, taking an action. Taking an action comprises determining that a signal carrying the transmission has a power level above a threshold, and communicating to a user of the mobile device that the other device is nearby. The information is sent to the access point at a time assigned to the device. At the time assigned to the device, also sending to the access point a request to upload data, receiving a transmission identifying a time to upload the data, and at the identified time, sending the data to the server. Receiving information from a beacon identifying the location of the beacon, and sending information including the location to the server. A beacon to transmit information identifying a location of the beacon, and in which the mobile wireless device also receives the information from the beacon and sends information identifying the location to the server.

In general, in one aspect, a system includes a server and a device configured to synchronize a database maintained on the server and on the device by: at a first one of the server or the device, updating at least a portion of the database, at the second one of the server or the device, updating at least a portion of the database according to a transaction received from the first one of the server or the device.

In general, in one aspect, a mobile wireless device wirelessly detects a presence of a second wireless device, receives information wirelessly from the second device, and displays information that is selected based on the information received from the second device.

Implementations may include one or more of the following features. The received information includes a value of an attribute of a person associated with the second device, and the displayed information comprises a greeting corresponding to the value of the attribute selected from a list of greetings The greeting is selected based on a preference stored in the first device. The received information includes a preference of a person associated with the second device. The received information includes a value of an attribute and a preference of a person associated with the second device, another preference is stored in the first device, and the greeting is selected from a list of greetings based on a preference determined to have priority Displaying information comprises determining that a user of the first device is entitled to view an item of information from the received information, and displaying the item of information. Displaying information comprises determining that the received information contains a value of a parameter, determining that a preference stored in the first device matches the value of the parameter, and displaying an identification of a user associated with the second device.

In general, in one aspect, when a wireless mobile device associated with a user receives information from a second device that describes a user of the second device, it determines that a part of the information matches information that describes people of interest to the user of the first device, and makes the user of the first device aware of the determination.

Implementations may include one or more of the following features. Making the user aware of the determination comprises displaying information describing a user of the second device on a display on the first device. Making the user aware of the determination comprises causing the first device to vibrate. Making the user aware of the determination comprises causing the first device to emit an audible sound. Making the user aware of the determination comprises causing the first device to illuminate a visual display. Detecting that the user of the first device encountered the user of the second device, and at a later time, reminding the user of the first device of the encounter. The reminding comprises displaying information about the user of the second device on a display on the first device. The reminding comprises displaying information about the user of the second device on a web page.

In general, in one aspect, a group of users of mobile wireless devices is identified, and each device is provided with information that its user belongs to the group.

Implementations may include one or more of the following features. Providing the information to the devices comprises, on a first device, identifying the group, informing the device that its user belongs to the group, instructing the device to add a user of a second device to the group, and causing the device to communicate information describing the group to the second device. Identifying a group of users of devices includes defining privileges of members of the group.

In general, in one aspect, data that represents an object, identifies an owner of the object, and identifies privileges of the owner to control a use of the object is stored on a first mobile wireless device.

Implementations may include one or more of the following features. Transferring data that represents the object to a second device by determining that the privileges indicate the that the owner of the object can transfer the object, storing data that represents the object on the second device, and erasing the data that represents the object on the first device. Transferring data that represents the object to a second device by determining that the privileges indicate the that the owner of the object can copy the object, and storing data that represents the object on the second device. Transferring data that represents the object to a second device by determining that the privileges indicate the that the owner of the object can copy the object, and that the data representing the privileges must be changed if the object is transferred or copied, and storing data that represents the object and data that represents the privileges on the second device, including changing the data that represents the privileges on the second device according to the privileges on the first device.

In general, in one aspect, it is determined that people having a set of properties responded to a promotion, and that a user of a device has properties in common with the set of properties, and data representing the promotion is sent to the device.

Implementations may include one or more of the following features. When the user encounters a second user, informing the second user that the first user's device received the promotion. Updating data about how the people responded to the promotion to include how the first user responded to the promotion and properties of the first user.

In general, in one aspect, using a first method of communication, information is sent from a beacon to a device identifying a location of the beacon, and using a second method of communication, information is received from the device including the location of the beacon, and information is sent to the device based on the location. The information based on the location may include a survey.

In general, in one aspect, an organizer of an event is enabled to identify, to a server, a first user, and a second user of mobile wireless devices that are carried by the users during the event, and to communicate messages from the server to the devices that facilitate a meeting of the two users.

In general, in one aspect, based on information about attendees of an event, a schedule of sessions of the event is adjusted and the adjustments of the schedule are communicated to mobile wireless devices carried by the attendees at the event.

Implementations may include one or more of the following features. Adjusting the schedule comprises, for each session, adjusting a list of attendees assigned to the session, and for each attendee, adjusting a list of sessions to which the attendee is assigned. Gathering information about attendees by communicating questions to the devices, enabling the attendees to answer the questions on the devices, and receiving the answers from the devices. The questions comprise a quiz. The questions comprise a survey. The information about attendees includes an identification of a first attendee that a second attendee should meet, and adjusting the schedule includes assigning the first attendee to a session to which the second attendee is assigned. Communicating the adjustments to a leader of a session. Receiving the information about attendees after a session, and adjusting the schedule before a subsequent session. The information about attendees includes information about a meeting desired by an attendee, adjusting the schedule includes adjusting the schedule to include the meeting, and communicating the adjustments includes communicating the adjustment to the device assigned to the user requesting the meeting, and communicating the adjustment to a device assigned to another user with whom the meeting is desired.

In general, in one aspect, a set of items to be evaluated by participants at an event is defined, subsets of the items are communicated to mobile wireless devices associated with the participants at the event, each item being communicated to at least one of the devices, each user is enabled to use his device to evaluate the items in the subset communicated the user's device, and the evaluations are combined to evaluate all the items in the set.

Implementations may include one or more of the following features. Communicating the combined evaluations to the mobile wireless devices, enabling each user to use his device to evaluate the combination of the evaluations, and updating the combined evaluations based on the second evaluating.

In general, in one aspect, first information about an attendee at an event that has been provided directly by the attendee and second information about the attendee that has been collected by a mobile wireless device assigned to the attendee with respect to the event is received, and based on the information, the person is determined to be a potential customer.

Implementations may include one or more of the following features. The second information includes one or more of attendance at sessions, which other devices the attendee's device has communicated with, which vendors the attendee's device has communicated with, and answers the attendee has provided to questions communicated to his device. Receiving third information including correlations between the first or second information and similar information for other attendees.

In general, in one aspect, a wireless network is installed at a venue, and mobile wireless devices receive information over the network, the information being divided into categories, in which a category of information to be received by a first device is different from a category of information to be received by a second device, and depends on a categorization of attendees at the venue to which the devices are to be assigned.

Implementations may include one or more of the following features. The categories include information about the current status of an event, information about customer relationships, information describing attendees at the venue a user of a device should meet, requests for a user of a device to meet with another attendee, schedule information, information from sources external to the network, and information from sources internal to the network.

Advantages include enhancing the ability of organizers of an event to facilitate face to face interactions between attendees, and enhancing the attendees' experience at the event. Attendees are able to exchange data representing objects, receive information, provide feedback, and organize groups. Schedules can be adjusted between activities based on feedback about the activities.

Other features and advantages will be apparent from the following description and the claims.

### DESCRIPTION

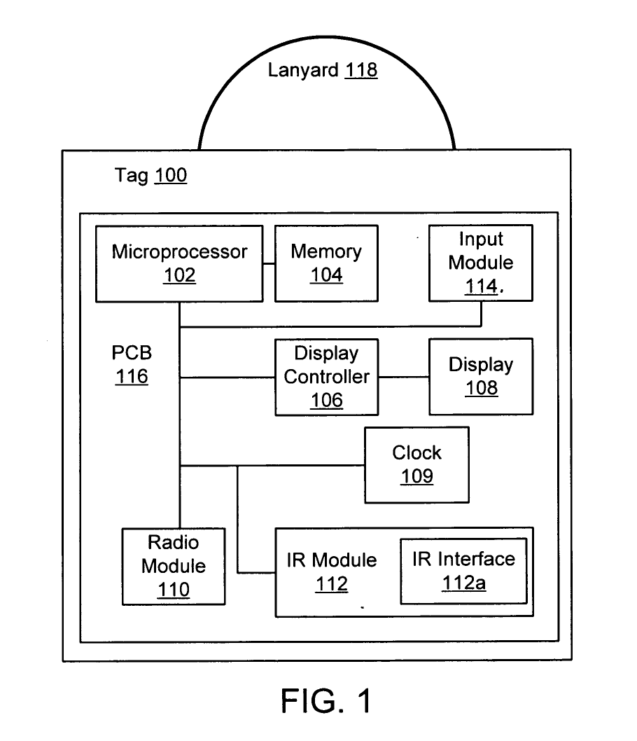

FIG. 1 is a block diagram of a mobile wireless device.

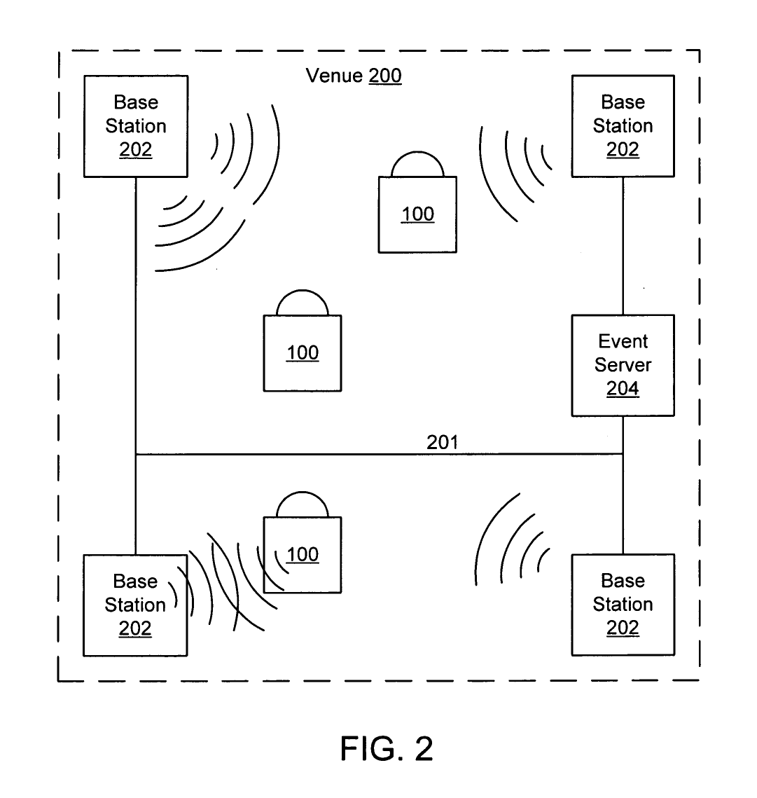

FIG. 2 is a block diagram of a wireless network.

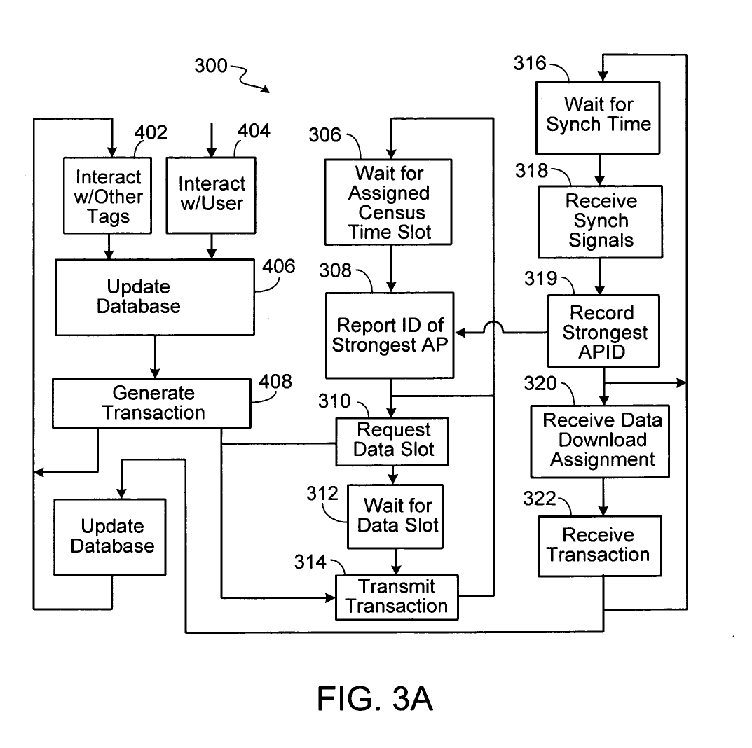

FIG. 3A, 4B, 5, 7-12, 13A, and 13B are flowcharts.

FIGS. 3B and 3C are timelines.

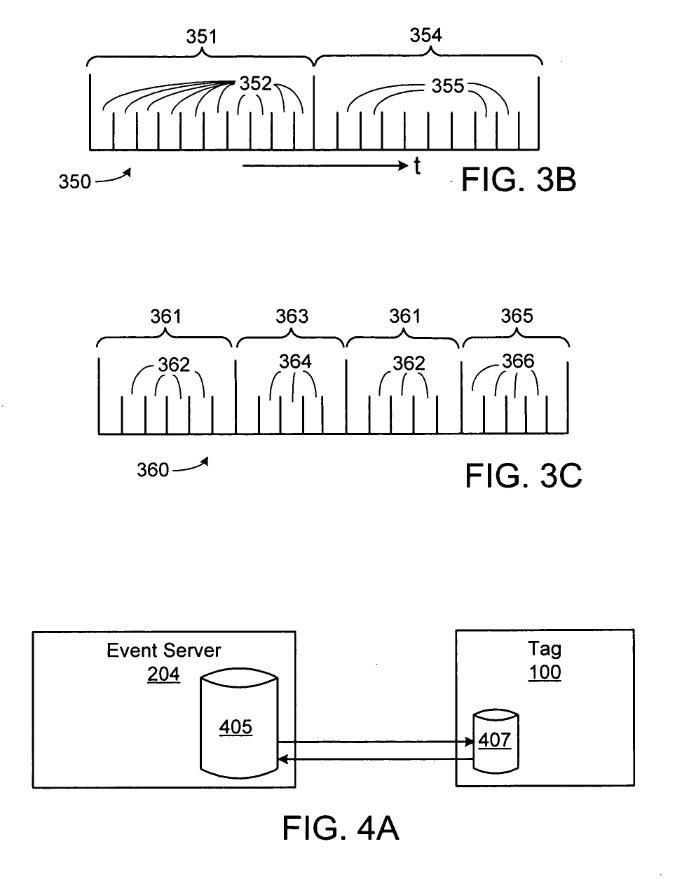

FIG. 4A is a block diagram of a database system.

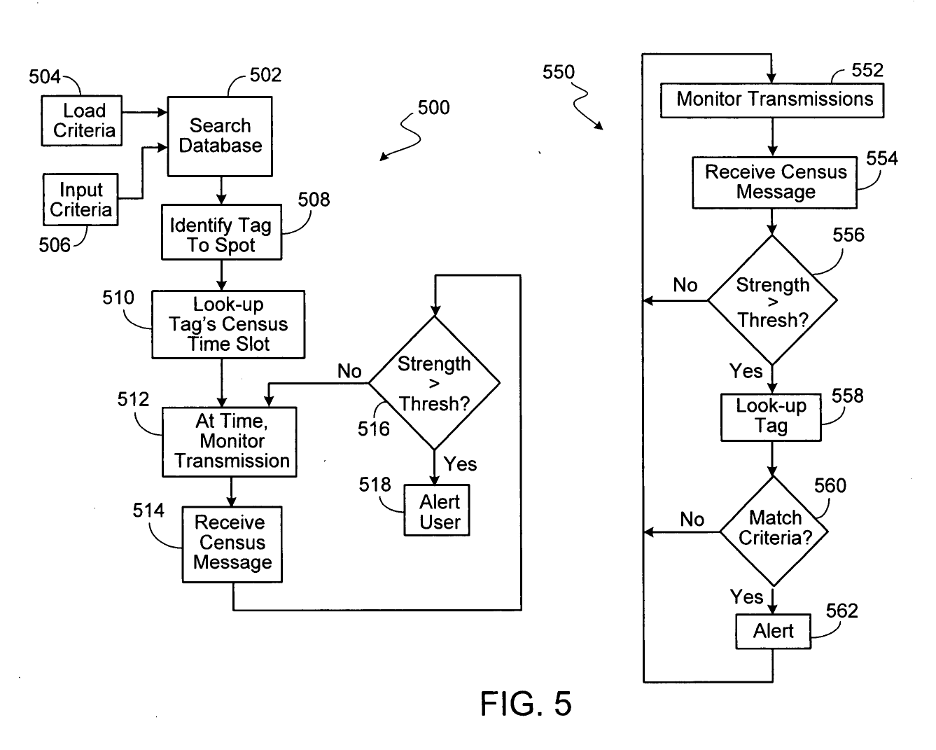

FIG. 6 is a block diagram of a beacon.

A convention is one example of a wide variety of events at which effective face-to-face interactions among people can be important. Such events can includes meetings, parties, training sessions, cruises, conferences, shows, educational forums, and governmental sessions, to name a few. Events often have hosts, organizers, or operators who have certain goals or objectives in terms of human interactions that they aim to foster. For example, a sponsor of an electronics show may want to maximize the number of visits by attendees to vendor booths. A sponsor of a customer gathering may want to facilitate interactions between company executives and key customers. In the case of a large party, the host may measure the success of the event based on an average overall satisfaction of people who attended.

Tags can be used to provide information to attendees of an event, allow the attendees to exchange information, for example, virtual business cards, and enable an event organizer to monitor interactions between attendees. The tags also enable the event organizer to poll the attendees and collect information about a variety of issues including their satisfaction with the event. Specific features include attendance tracking, surveys, networking activity, lead capture, and audience response. By collecting large amounts of real-time data about what goes on at an event, such features can make an event more effective, more efficient, and more provably valuable to its organizers and their customers. Such data can be used during an event to improve interactions as they happen, and can be further analyzed after an event to demonstrate its success and guide planning for future events.

As shown in FIG. 1, a tag 100 includes a microprocessor 102, a memory 104, such as flash memory, and various interface electronics and communication devices, including a display controller 106, a display 108, a clock 109, a radio module 110, and an infrared (IR) module 112 with an IR interface 112a. These components are interconnected on a printed circuit board 116, though any number or combination of them could be integrated into one or more circuit modules. A user of the tag can provide input using an input module 114, which may be connected to buttons (not shown), a touch sensitive element of display 108, a voice-activation system (not shown), or other input mechanism (not shown).

The tag is adapted to hang around the wearer's neck using a lanyard 118, although it can have a clip or other attachment mechanism on the back (not shown) to attach it to the wearer's clothing. The lanyard 116 is preferably an adjustable length lanyard so that the shorter length allows the tag to hang high on the wearer's chest in the badge mode, when it is to be read by someone else, but uses the longer length needed when the tag is to be raised for reading by the wearer. When the tag 100 is to be read by someone other than the wearer, it is in the “badge mode.”

The display 108 on the tag 100 and the communications interface 112a of infrared module 112 both face outwardly so that communication is possible with another tag wearer standing face-to-face with the first wearer. In that way, each wearer can see the display 108 of the other wearer's tag 100, and the communication interface 112a is facing a similar communication interface 112a on the tag 100 of the other wearer.

When two people wearing tags 100 are standing face-to-face, their respective IR interfaces 112a can communicate with each other. In some examples, the IR interface 112a is tuned to begin information exchanges at a range of about three feet. In that way, data contained in the memory 104 of each tag 100 can be passed to the other tag 100. Alternatively, the tags may communicate with each other by other means, such as radio, for example, using the Bluetooth standard.

As shown in FIG. 2, a number of tags 100 can interact through the medium of a radio network 201. As noted above, the tag 100 also contains a radio module 110. This provides a radio interface that can be used to communicate with base stations 202 throughout a venue 200 where the tags 100 are in use. The base stations are in communication with an event server 204 using a standard network technology such as wired Ethernet or 802.11-based wireless Ethernet. The radio interface has a number of features that facilitate applications of the tags, discussed below.

The radio module 110 in each tag 100 operates as shown in the flowchart 300 of FIG. 3A and the timeline of FIG. 3B. On a radio communication channel, the census channel 350, over which the radio module 110 is configured to communicate, time is divided into a repeating succession 351 of time slots referred to as census slots 352. Each tag 100 is assigned to a specific census slot. In some examples, the slots are assigned sequentially as tags are activated. Other assignment schemes are possible. An additional time period is a sync period 354, which is divided into sync time slots 355 assigned to individual access points 202. During the sync period 354, each of the access points 202 listens for a time synchronization signal during time slots 355 assigned to other access points and then broadcasts the time synchronization signal at its own assigned sync slot 355. The tag 100 listens for transmissions from the access points 202 during each sync slot 355, and records in memory 104 an ID code identifying an access terminal 202 from which it received the strongest signal (319). It uses the received sync signal to keep its onboard clock 109 in sync with that of the event server 204 (318). In this way, the sync signal propagates from the event server 204 to all the access points 202 and tags 100. When its own time slot arrives, the tag 100 activates its radio module 110 and transmits a census message which includes the ID of the strongest access point (308). Access points 202 constantly monitor transmissions by the tags 100, and, if the access points are deployed appropriately, at least one access point will receive the census message from the tag at any time. While waiting (306) for its own time slot 352 or the sync period 354 to occur, i.e., during time slots 352 assigned to other tags, a tag 100 keeps its radio off to save energy.

In addition to reporting the ID of the strongest access point, the tag 100 may request allocation of a data transmission slot (310). As shown in FIG. 3C, on a second radio communication channel, the data channel 360, time is divided into a block 361 of data broadcast time slots 362, a block 363 of individual download time slots 364, another block 361 of broadcast time slots 362, and a block 365 of individual upload time slots 366. The individual download and upload slots 364 and 366 are not pre-assigned to individual tags. When a tag 100 has data to report, for example, the identities of other tags it has communicated with since it last reported, it notes this in its census message (310) to the access point 202. The access point 202 assigns the tag 100 to an available upload time slot 366 and communicates that assignment to the tag over the data channel during one of the broadcast time slots 362. The tag puts its radio module to sleep until its assigned data time slot 366 (312), to save energy, and then wakes up and transmits its data to the nearest access point (314). Similarly, if the server 204 has information to send to a specific tag, the nearest access point 202 assigns a download slot 364 and communicates this during a broadcast slot 362 (320). The tag wakes up and downloads the data at the assigned time slot 364 (322). Both the census message and data transmissions from the tags 100 are broadcast, that is, the tag 100 doesn't direct its message to a particular access point 202. The tag 100 receives an acknowledgement from the access point 202 if the transmission is received, but does not receive any feedback if the it is not received. The download and upload time slots could be intermingled or could be clustered in alternating blocks 361, 363, 365 as is shown in FIG. 3C.

At least some of the data stored in tags 100 and on the event server 204 is in the form of databases 405, 407, as shown in FIG. 4A. In particular, each tag stores in its own database 407 a subset of the data that is contained in the database 405 on the server. Updates to data transmitted between tags and the server are in the form of transactions, as shown in FIG. 4B. The flow chart 400 partially overlaps flow chart 300 (FIG. 3A). Transactions indicate what data is to be changed and how. In some examples, transactions are in the form of XML data.

When a tag 100 has new data, for example, as a result of interactions with other tags (402) or with its own user (404), it updates its own database (406) and generates a transaction representing the update (408). It then transmits the transaction to the event server 204 as discussed above. Upon receiving the transaction (410), the server applies the transaction to its own database, updating the database to match the tag (412). Similarly, when a change originates at the server, it updates its master database (414) and generates a transaction representing that update (416). That transaction may be applicable to more than one tag, and the identities of the tags to which it is applicable is one of the values stored in the transaction. The event server 204 transmits the transaction to the tags as discussed above. When the affected tags receive the transaction (322), they make the appropriate changes to their own databases (418). In this way, the databases on the event server 204 and on the tags 100 are kept synchronized.

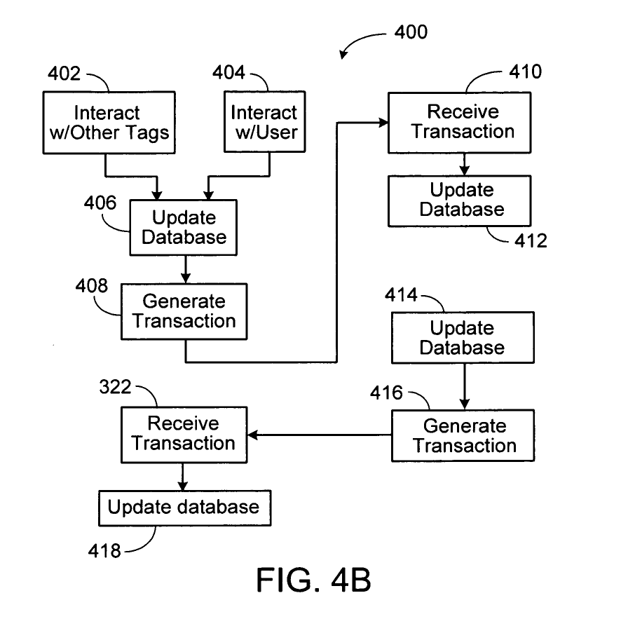

One of the tag applications facilitated by these radio features is spotting, as shown in FIG. 5. It can be useful to users of tags to know when certain other users are nearby. These could be specific other users (for example, John Smith) or could be users meeting certain criteria (for example, other users of Windows XP who live in Houston). Information about each user in the venue 200 is stored in the database of each tag 100. As shown in flow chart 500, a tag can search that information to find other users who meet criteria established by the tag's user (502). The criteria could be their identity, if the user knows whom he wants to meet, or could include factors such as their job, where they live, or how they responded to a particular survey question. A user may load such criteria ahead of time (504), for example, on a web site, or they may do so directly on their tag (506) using whatever input device it is provided with.

Criteria defining a match between users might be set by someone other than the users themselves, for example, an organizer of an event may determine that two particular users, or any two users meeting some criteria, should meet. This information is stored in the database just as is any other information and can be loaded onto the tags when they are initially set up or sent to them as any other database update.

In some examples, a tag 100 may identify the tag its wants to spot (508) and determine that tag's assigned census time slot (510) from its own database. The tag 100 then places its radio module 110 in a receive mode at that time slot and monitors transmissions to see whether the other tag is transmitting its census message (512). If it does receive the census message (514) and the strength of the signal is over a pre-determined threshold (516), the tag 100 determines that the other tag is nearby and alerts the user of the tag 100 (518). Alternatively, as in flow chart 550, a tag 100 could monitor census messages reported during all of the other tags' census time slots (552) and look up in its database (558) each tag for which it detects a transmission (554) having a strength over the threshold (556). If any detected tag is associated in the database with criteria indicating it should be spotted (560), the user of the tag is alerted (562).

In some examples, different tags may be loaded with different data or may be configured to display different data when alerting their user to a spotted tag. For example, an event organizer's tag may be loaded with all available information and be able to display all information about any attendee the organizer encounters. An attendee's tag could be loaded with less information or, if all information is loaded, configured to not display certain information, such as the home address of other attendees. Additional classes of users could be defined, for example, at a sales conference, sales people may be able to view past purchase history of potential customers.

The IR interfaces 112a of the tags enable them to determine their locations in a venue more precisely than by determining the strength of the nearest access point, by using IR beacons. In some examples, an IR beacon, as shown in FIG. 6, includes an array of IR emitters 606, such as LEDs, controlled by a microprocessor 602 and an IR module 604 and configured so that a tag's IR interface 112a will receive IR signals sent from a beacon located anywhere in a room. The beacon is essentially, in this respect, a powerful tag, and can be used to transmit any information that a tag is programmed to receive over its IR interface, for example, an identification of the room in which the IR beacon is located. In some examples, a simpler beacon is used, in which the IR emitters simply flash, and the timing between flashes identifies the beacon. Tags detecting the flashes compute the time difference and either look up in their own databases which location the timing corresponds to or send the information to the event server and let it determine where they are and return the location to the tag. Such simplified beacons could use a radio to receive the sync signal from the access points to keep their systems up-to-date, but have no need to transmit over their radio.

A number of other features are enabled by the tag-to-tag communication provided by the IR module 112. In many cases, these features also involve database updates, which are performed as discussed above.

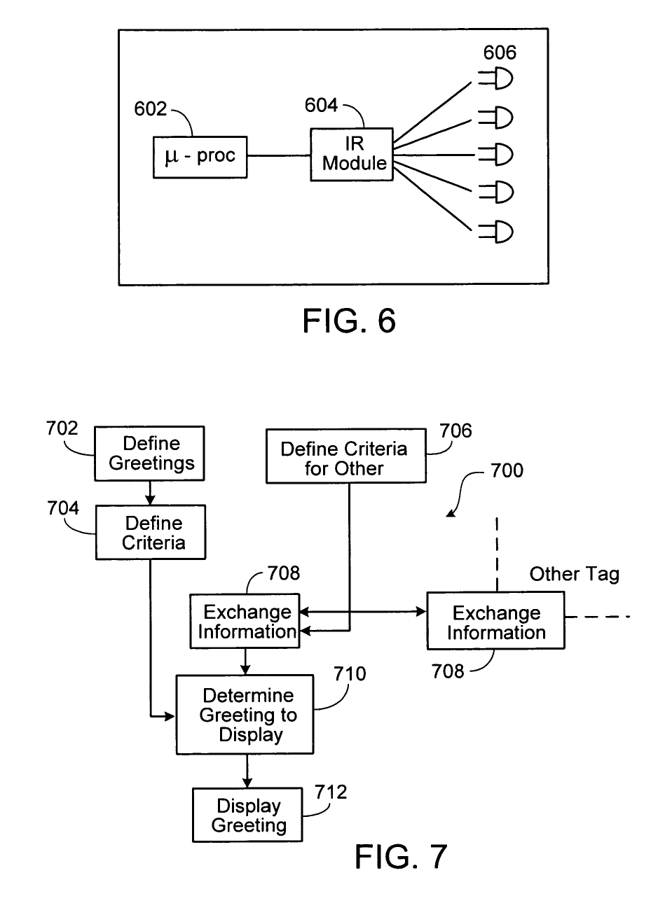

When two attendees wearing tags meet, their tags exchange information using their IR interfaces 112a or other local communications capabilities. The information could simply be identification, allowing each tag to look up additional information about the other in its database, or it could include additional information without requiring the other tag to look it up. In some examples, the first things the tags do with this information is to provide a greeting for the user of the other tag, as shown in FIG. 7. Following flow chart 700, each user defines a set of potential greetings (702) either in advance of the meeting on a website or on the fly using the interface of the tag. These greetings may be selected from a set of pre-defined greetings, may be semi-customized by combining pre-defined greeting templates with information about the user, or may be freely created by the user, depending on the capabilities of the tag.

Each user may also define criteria describing how to determine which greeting to display to another user (704), for example, if the user is from a particular location, the device is to display a greeting appropriate to that location. A vendor could customize his tag to show different greetings based on what types of products an attendee is interested in. For example, a vendor who sells a particular type of CRM solution can create a greeting targeted to attendees whose profiles reveal they are interested in CRM solutions. The greeting could say “Ask me about CRM tools from ABC Co.” Alternatively, or in addition, each user may define criteria describing which greeting they wish to be presented with by another user's tag (706), or which information they want to know about other users that might be available to be displayed through a greeting (if they don't know what greetings other users may have defined). Greetings and criteria may be entered directly through the tag's input module 114 or through a web interface or other external interface and loaded on to the tag in a database update.

After exchanging information (708), each tag determines which greeting to display (710), based either on its own user's preferences, those of the other user, or some algorithm for resolving a conflict between the two, if they would result in different greetings. The tag then instructs the display controller 106 to display the selected greeting on the display 108 (712). If more than one greeting is selected, the tag 100 may use the display 108 to show multiple greetings in turn, depending on the capability of the display 108.

Another potential application is creating and interacting with groups. Groups of users, for example, all the attendees from a particular company, may be defined ahead of an event, and the fact of a users' membership in the group may be stored in the tags' databases, so that members of the group may spot each other or be able to exchange specific information, such as which potential customers they have each encountered. People who belong to a group can send each other messages, or potentially share annotations they've made about people they've met, booths they've visited, sessions they've attended, etc. Members of a group can also discover where other members of the group are, for example, what room a member is in, as determined by a beacon in that room.

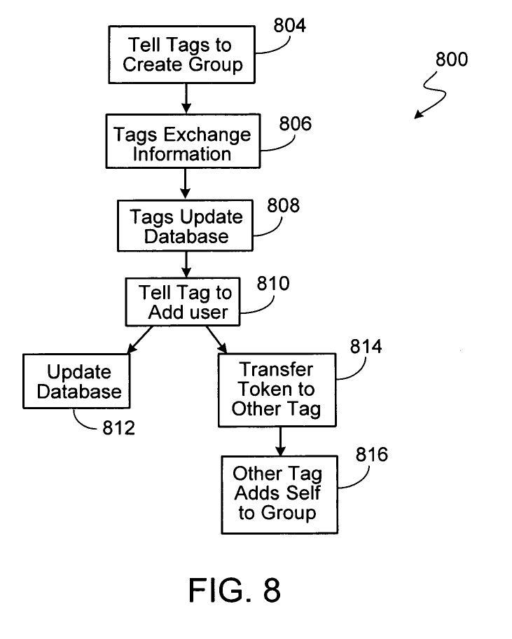

Groups may also be created on the fly, as shown in FIG. 8. For example, two arbitrary users may decide to create a group and instruct their tags to do so (804). The tags exchange (or one tag creates and transfers to the other) information describing the group (806), and both add their membership in the group to their next database update (808). Then, each time one of the members of the new group meets someone he wants to add to the group, he can instruct his tag (which has already identified the other user when it exchanged greetings with his tag) to add that user to the group (810), and it will do so on its next database update (812). Alternatively, the tag could transfer a token to the other user (814), which enables the other user to add himself to the group (816), if he so desires. In this way, a group could spread “virally”, from user to user, ultimately including people the original group creators would not have thought to include.

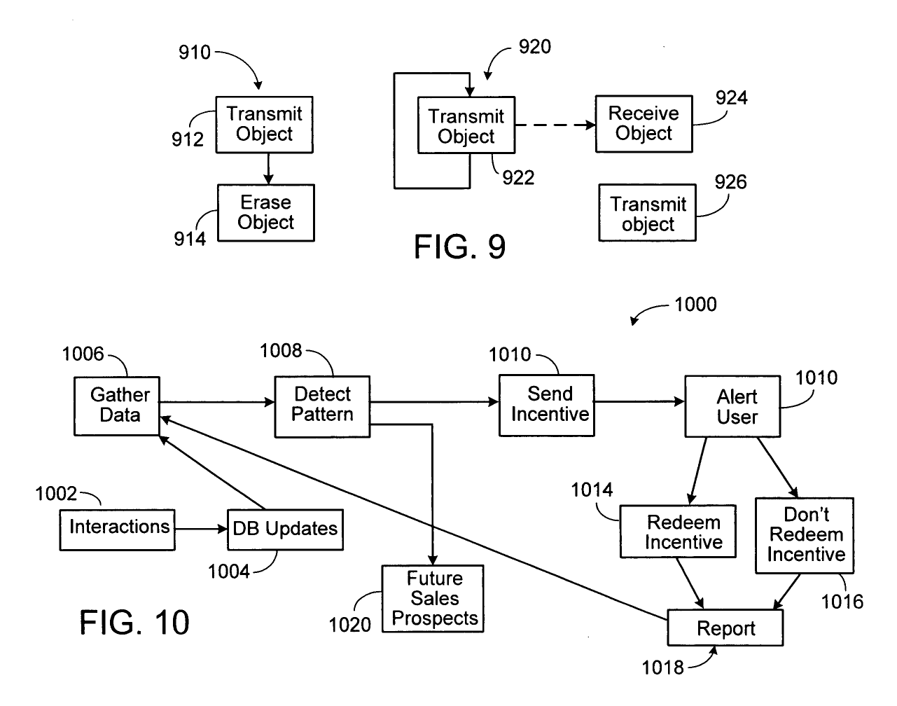

In addition to storing databases, the memory 104 of the tags could be used to store virtual objects. The IR interfaces 112a of the tags can then be used to exchange these virtual objects. When two users are in range, one user could transfer an object stored in his tag to the other user's tag, as shown in FIG. 9. Depending on the nature of the object, this could take several forms. Some objects may be designated to only have a single copy, as shown in flow chart 910, so that a tag transferring the object (912) must remove the data representing the object from its own memory (914). Other objects maybe copied, but only to one iteration, as shown in flow chart 920, such that a first user can give copies directly to as many additional users as he wishes (922), but users who receive the object (924) cannot in turn copy or transfer the object to other users (926). Various combinations of who can transfer an object, whether it can be copied or must be removed from the source tag and whether the copied version is identical to the original or has different properties are possible.

Some examples of transferable objects include invitations or tickets, gift certificates, information (e.g., business cards, web site addresses), tokens representing privileges (e.g., the right to join a group), or objects of value in games. Some objects may have variable attributes, for example, a gift certificate may have a value that increases if a user completes certain tasks (verifiable by their tag), such as visiting certain vendor booths at a trade show, or transferring invitations to other users to attend an event.

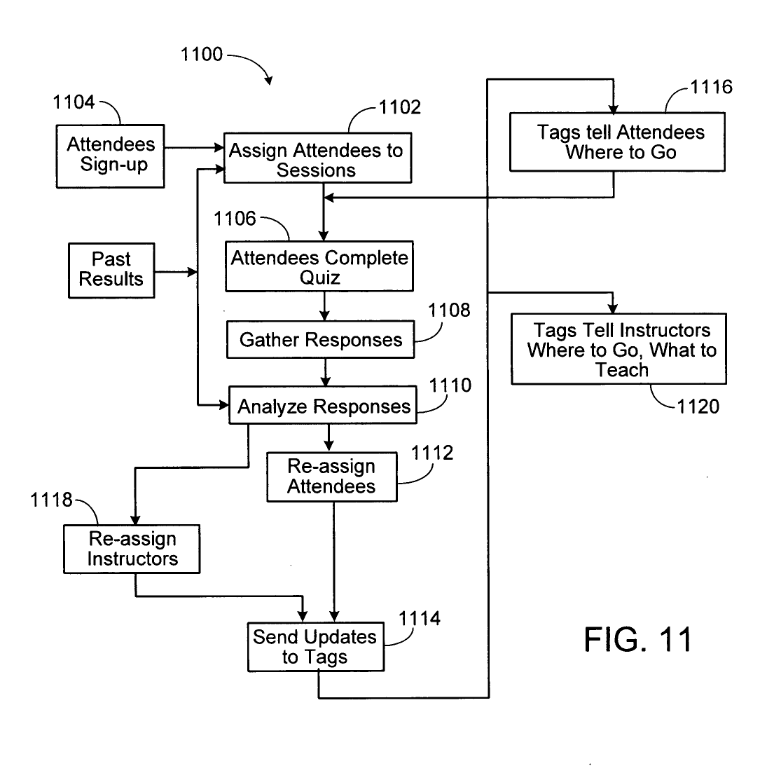

In general, objects can also be used to encourage certain behaviors of attendees, such as the example of the gift certificate just mentioned. In some examples, as shown in FIG. 10, an event organizer or a participant may want an attendee to visit a particular booth at a trade show or similar event. Following flow chart 1000, the organizer may transfer to the user an object representing an incentive, such as, a promise of a gift if they visit a particular booth. The determination of which incentive to provide, and whom to provide it to, can be based on the ongoing interactions (1002) of attendees, as reported by their tags during database updates (1004), which the event organizers are able to monitor (1006). If the event organizers (or an automated system operating on their behalf) observe that a particular incentive is effective with people having particular attributes (1008), they will want to send that incentive to those people (1010). It may be that an attendee does not have those attributes at first, but acquires them over the course of an event.

An attendee may be identified as a potential customer in step 1008 based on both the information he provided about himself and based on information collected by his tagtag in step 1002, including information about whom he interacted with, which events he participated in, which vendors he visited, how he answered surveys, etc. With enough data collected from enough attendees (1006), the event server can accurately determine correlations between these various factors and behaviors of interest to the organizers, for example, purchasing a particular product. This information can also be used to help vendors determine which attendees to pitch and how to tailor their pitches, or to send information to the vendor's customer management system for later follow-up.

For example, the data may indicate in step 1008 that attendees who have met twenty other attendees who already bought a product from a certain vendor are likely to respond to an offer for a discount on that vendor's product. An attendee won't have met twenty other attendees at the beginning of an event, but may do so over the course of the event. When his tag provides a database update (1004) indicating that he has met his twentieth person who bought a product from that vendor, the event server will transfer the offer for a discount to the attendee (1010). The attendee's tag will then inform the attendee that the offer has been received (1012). Alternatively, potential offers could be loaded in the tag's database ahead of time, and made available to the attendee by the tag itself when it detects the qualifying events. The tag could then update the server to inform it the offer has been delivered. Whether the attendee redeems the offer (1014) or not (1016), and how long it took him to do so, is subsequently added to the data on which the original determination to give the offer was based, (1018) so subsequent offers can be more finely tuned.

The information used to predict the effectiveness of a promotion may also be used to predict future sales prospects. For example, at the end of an event, after all the available data has been collected and analyzed, additional correlations may become apparent. A vendor who participated in the event may be provided with a list of attendees who are likely future sales prospects (1020). Such a list might include which sales person, if any, interacted with that attendee, and what other data gives rise to the prediction, so that the vendor can make the best use of the list in following up on leads.

As mentioned above, organizers of an event may wish to encourage attendees to interact and meet other attendees. Attendee interaction can be generally encouraged, for example, by providing incentives for attendees to exchange virtual business cards, through their tags, with as many other attendees as possible. With the volume of information available in the databases in the tags and the ability of the network to update that information dynamically, additional features are possible. By monitoring ongoing activities, as reported by the tags, an organizer can see how much of a certain desired behavior or type of interaction is happening, and then create and/or change the incentives on the fly in an effort to facilitate more of the desired behavior or type of interaction. An organizer of an event may want attendees having certain properties to meet attendees having certain other properties, for example, the organizer may want attendees in the market for a new database to meet attendees who have used databases other than those used by the attendees in the first group. This objective can be furthered by instructing each user's tag to alert the user when it spots a tag belonging to a user in the complementary group.

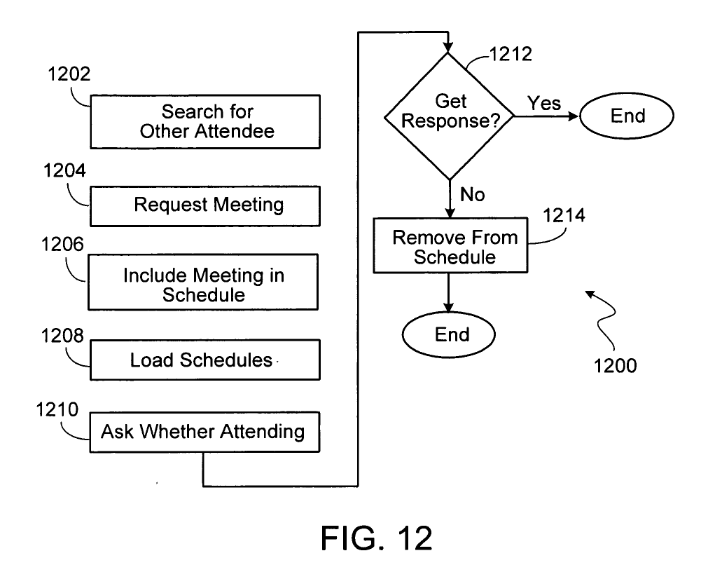

Another application enabled by the tags is dynamic scheduling. In one example, a training event includes instructional sessions, each led by an instructor and to be attended by a number of attendees. As shown in flowchart 1100 in FIG. 11, an application running on the event server 204 assigns attendees to sessions (1102). Which attendees are assigned to which sessions may initially be based on information the attendees provided when signing up for the training (1104). At the beginning of the event, the attendees complete a quiz using the input capabilities of the tags to answer questions related to the subject matter of the training (1106). The event server 204 collects the quiz responses (1108) and the scheduling application uses this information to compare the relative experience or knowledge of the trainees and determine whether their allocation to the various sessions is appropriate (1110). The application, possibly with human intervention, adjusts the assignment of attendees to sessions to make sure each attendee is in the most appropriate session (1112), based on the quiz responses, instructor abilities, and such other information as the size of the room and available resources. This may include adjusting the intended subject matter of a session, for example, it may split a session intended to be introductory in nature into two sessions (assuming an appropriate number of session leaders are available), and assign attendees with little experience to one and attendees with a lot of experience to the other. The end result is that the right attendees get assigned to the right instructor, with the right subject matter, in the right sized room, and with the right resources.

After the schedule has been updated, the event server communicates it to the attendees' tags through a database update as described above (1114). Attendees then consult their tags to determine which sessions to attend (1116). This process can be repeated after each session, with attendees completing surveys or quizzes to determine how they responded to the session (1106). The attendance of each session can be rescheduled on the fly, with new schedules being sent to attendees between each session, repeating steps 1108, 1110, 1112, and 1114 after each session. In addition, instructors could be reassigned (1118) or even their subject matter changed and the instructors informed of these changes between sessions (1120). If information is available from one event to another, quiz and survey results can also be used to inform future scheduling (1122), to obtain even more accurate assignment of attendees to sessions, effectively with “hindsight.” For example, if a quiz after a session shows that attendees who answered an earlier question a certain way in fact meant something other than what the author of the quiz intended, people who answer that question the same way in a future event may be assigned to a different session.

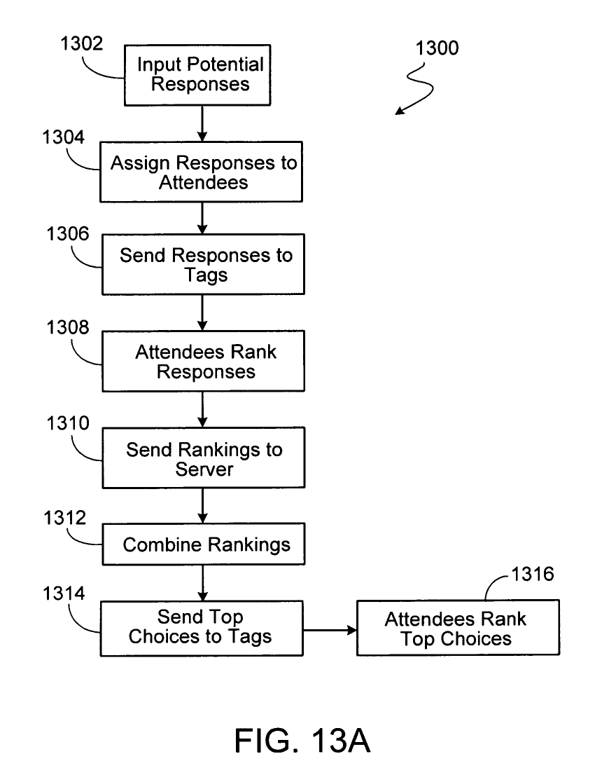

In another example, an attendee may wish to set up a specific meeting with another attendee. As shown by flowchart 1200 in FIG. 12, the attendee may use a web site provided by the event organizer to access a list of attendees, and either conduct a search for other attendees with certain properties or directly enter the identification of a specific attendee (1202). When he has located the person with whom he wishes to meet, the attendee requests a meeting (1204). The scheduling application takes this request into account when developing the schedule and arranges for the meeting to take place (1206). When it loads the schedule into the attendees' tags, the meeting is included and the attendees notified (1208). This may include asking the requested attendee if he wishes to attend the meeting (1210) and getting his response (1212) and informing the requesting attendee and updating his schedule (1214), if necessary, to remove the meeting if it was declined. This feature could be combined with the other scheduling features described or may operate independently, for example, at a trade show where there are no scheduled sessions for which attendance needs to be arranged.

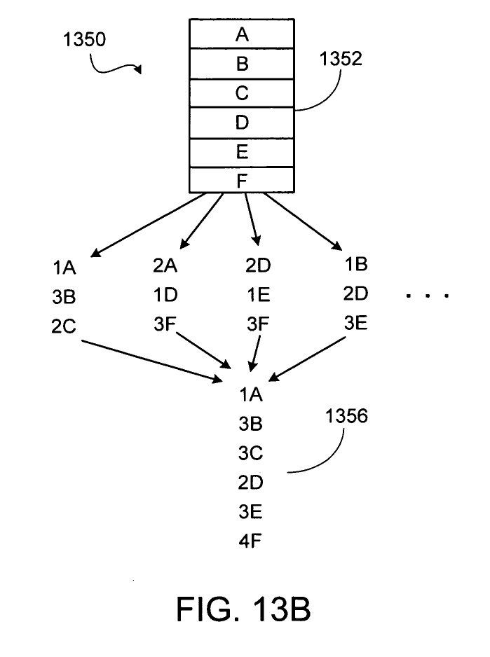

When surveys are distributed to attendees of an event through their tags, a high response rate is possible due to the ability of the tags to report the survey results wirelessly. In some examples, an event organizer may take advantage of this response rate by distributing the survey questions as shown in FIGS. 13A and 13B. For example, suppose the organizer wants participants to rank one hundred potential product names. Asking each attendee to rank all one hundred will lead to attendees paying little attention to many of the names. Narrowing the field to a more manageable number of names, e.g., ten, ahead of time imposes the organizer's own bias on the results, which they may find undesirable. To improve the results, the organizer may distribute the responses by following the process of flow chart 1300 and data flow 1350. First, they provide all one hundred potential names 1352 to the event server 204 (1302). A program running on the server randomly assigns sets of ten names 1354 to each attendee (1304) and the server transmits the survey to the tags, each tag receiving only the ten names assigned to its attendee (1306). The attendees each rank the ten names his tag presents to them (1308), and the tags return the results to the event server (1310). The application on the event server then combines the results to produce an aggregate ranking 1356 of all one hundred potential names (1312). After the server has combined the results to produce the aggregate ranking 1356, it can send the top ten or top twenty names to everyone (1314), and allow one more vote by everyone (1316). This has the benefit of everyone ultimately voting on the same list, with the contents of the list having been selected by a non-biased process. Various different algorithms could be used to combine the results. Just as surveying a small sample of a large group can produce results that the majority of the group agrees with, combining many small samples can produce aggregate results that are similarly valid. The event server and tags facilitate this by allowing distributed surveys dynamic updating of information. The number of items to begin with and to distribute to each attendee will depend on many factors, including the desired results, the subject matter, the number of attendees, etc.

In another example, information may be provided to users of tags over the course of an event. This includes some of the examples discussed above, such as scheduling information, surveys, meeting requests, and promotions. Other information to be provided may include live data about the progress of the event, information about potential customers, a list of people an attendee should meet with, or external information, such as sports scores and stock prices. Which information is provided to a particular attendee may depend on numerous factors, including membership in particular groups, as discussed above in the context of the information made available when spotting other tags.

For example, the organizer of an event may have his own tag and want to receive real-time information that tells him how well the event is going, such as how many attendees are exchanging virtual business cards with other attendees, and with what frequency. This may be information that they do not want shared with other attendees, at least not in its raw form. The organizer may want members of the press who have tags to receive filtered information, such as key facts about the number of attendees and real-time statistics that create a favorable impression about the success of the event. Regular attendees may be provided with sports scores, headlines, and stock prices. This could be done simply to entertain the attendees, or could be designed to avoid the need for them to leave the event to get such information, increasing the time they spend interacting with other attendees. Vendors may be provided with customer relationship information, while executives of companies sponsoring the event may receive such information as how well their sales force is performing in objectives such as meeting potential customers.

Various combinations of these applications can be used to make the attendee experienced more customized. This can help to bring some of the advantages of on-line services, such as e-commerce sites that remember customers' buying habits, to face-to-face gatherings, while still preserving the intimacy and immediacy of such gatherings. These include personalizing the experience, for example, causing a vendor's tag to greet a visitor based on the visitor's profile, and giving the vendor guidance on how to tailor his pitch based on the visitor's profile and on-site behavior. Other examples include driving traffic to exhibit booths and closed-loop marketing—measuring which promotions lead to booth visits and which boot visits lead to requests for follow-up, and adjusting actions accordingly.

Other implementations are within the scope of the following claims.

What is claimed is:

1. A method comprising
at a mobile wireless device that has a device identifier, is located in a meeting venue, and communicates with a server through one or more wireless access points associated with the meeting venue,
receiving, from one of the access points, access point information that identifies the access point, and
sending information including the device identifier to the access point.

2. The method of claim 1 also comprising, deactivating the device at times when it is not doing the receiving or sending.

3. The method of claim 1 also including
receiving from another one of the access points, access point information that identifies the other access point, and
determining with which of the two access points the communication is stronger, and
sending the access point information of the access point with which the communication is stronger.

4. The method of claim 3 also including sending updated access point information as the identity of the access point with which communication is stronger changes.

5. The method of claim 1 also comprising
receiving a synchronization signal from one of the access points.

6. The method of claim 1 also comprising
at a time assigned to another device, monitoring for a transmission from that device.

7. The method of claim 6 also comprising, if the transmission is detected, taking an action.

8. The method of claim 7 in which taking an action comprises
determining that a signal carrying the transmission has a power level above a threshold, and
communicating to a user of the mobile device that the other device is nearby.

9. The method of claim 1 in which the information is sent to the access point at a time assigned to the device.

10. The method of claim 9 also comprising
at the time assigned to the device, also sending to the access point a request to upload data,
receiving a transmission identifying a time to upload the data, and
at the identified time, sending the data to the server.

11. The method of claim 1 also comprising
receiving information from a beacon identifying the location of the beacon, and
sending information including the location to the server.

12. A system comprising
at least one access point, in communication with a server, to receive transmissions from mobile wireless devices, and
at least one mobile wireless device that has a device identifier to
receive, from the access point, access point information that identifies the access point, and
at a time assigned to the device, send information, including the device identifier, to the access point.

13. The system of claim 12 also comprising
a beacon to transmit information identifying a location of the beacon,
and in which the mobile wireless device also receives the information from the beacon and sends information identifying the location to the server.

14. A system comprising
a server and a device configured to synchronize a database maintained on the server and on the device by:
at a first one of the server or the device, updating at least a portion of the database,
at the second one of the server or the device, updating at least a portion of the database according to a transaction received from the first one of the server or the device.

15. A method comprising,
in a mobile wireless device, wirelessly detecting a presence of a second wireless device,
receiving information wirelessly from the second device, and
displaying information that is selected based on the information received from the second device.

16. The method of claim 15 in which
the received information includes a value of an attribute of a person associated with the second device, and
the displayed information comprises a greeting corresponding to the value of the attribute selected from a list of greetings

17. The method of claim 16 in which the greeting is selected based on a preference stored in the first device.

18. The method of claim 15 in which
the received information includes a preference of a person associated with the second device.

19. The method of claim 15 in which
the received information includes a value of an attribute and a preference of a person associated with the second device,
another preference is stored in the first device, and
the greeting is selected from a list of greetings based on a preference determined to have priority

20. The method of claim 15 in which displaying information comprises
determining that a user of the first device is entitled to view an item of information from the received information, and
displaying the item of information.

21. The method of claim 15 in which displaying information comprises
determining that the received information contains a value of a parameter,
determining that a preference stored in the first device matches the value of the parameter, and
displaying an identification of a user associated with the second device.

22. A method comprising
when a wireless mobile device associated with a user receives information from a second device that describes a user of the second device,
determining that a part of the information matches information that describes people of interest to the user of the first device, and
making the user of the first device aware of the determination.

23. The method of claim 22 in which making the user aware of the determination comprises
displaying information describing a user of the second device on a display on the first device.

24. The method of claim 22 in which making the user aware of the determination comprises causing the first device to vibrate.

25. The method of claim 22 in which making the user aware of the determination comprises causing the first device to emit an audible sound.

26. The method of claim 22 in which making the user aware of the determination comprises causing the first device to illuminate a visual display.

27. The method of claim 22 also comprising
detecting that the user of the first device encountered the user of the second device, and
at a later time, reminding the user of the first device of the encounter.

28. The method of claim 27 in which the reminding comprises displaying information about the user of the second device on a display on the first device.

29. The method of claim 28 in which the reminding comprises displaying information about the user of the second device on a web page.

30. A method comprising
identifying a group of users of mobile wireless devices, and
providing to each device, information that its user belongs to the group.

31. The method of claim 30 in which providing the information to the devices comprises, on a first device,
identifying the group,
informing the device that its user belongs to the group,
instructing the device to add a user of a second device to the group, and
causing the device to communicate information describing the group to the second device.

32. The method of claim 30 in which identifying a group of users of devices includes defining privileges of members of the group.

33. A method comprising
on a first mobile wireless device, storing data that represents an object, identifies an owner of the object, and identifies privileges of the owner to control a use of the object.

34. The method of claim 33 also comprising
transferring data that represents the object to a second device by
determining that the privileges indicate the that the owner of the object can transfer the object,
storing data that represents the object on the second device, and
erasing the data that represents the object on the first device.

35. The method of claim 33 also comprising
transferring data that represents the object to a second device by
determining that the privileges indicate the that the owner of the object can copy the object, and
storing data that represents the object on the second device.

36. The method of claim 33 also comprising
transferring data that represents the object to a second device by
determining that the privileges indicate the that the owner of the object can copy the object,
and that the data representing the privileges must be changed if the object is transferred or copied, and
storing data that represents the object and data that represents the privileges on the second device, including changing the data that represents the privileges on the second device according to the privileges on the first device.

37. A method comprising
determining that people having a set of properties responded to a promotion,
determining that a user of a device has properties in common with the set of properties, and
sending data representing the promotion to the device.

38. The method of claim 37 also comprising
when the user encounters a second user,
informing the second user that the first user's device received the promotion.

39. The method of claim 37 also comprising
updating data about how the people responded to the promotion to include how the first user responded to the promotion and properties of the first user.

40. A method comprising
using a first method of communication, sending information from a beacon to a device identifying a location of the beacon, and
using a second method of communication, receiving information from the device including the location of the beacon, and
sending information to the device based on the location.

41. The method of claim 41 in which the information based on the location includes a survey.

42. A method comprising
enabling an organizer of an event to identify, to a server, a first user and a second user of mobile wireless devices that are carried by the users during the event,
communicating messages from the server to the devices that facilitate a meeting of the two users.

43. A method comprising,
based on information about attendees of an event, adjusting a schedule of sessions of the event and communicating the adjustments of the schedule to mobile wireless devices carried by the attendees at the event.

44. The method of claim 43 in which adjusting the schedule comprises
for each session, adjusting a list of attendees assigned to the session, and
for each attendee, adjusting a list of sessions to which the attendee is assigned.

45. The method of claim 43 also comprising
gathering information about attendees by
communicating questions to the devices,
enabling the attendees to answer the questions on the devices, and
receiving the answers from the devices.

46. The method of claim 45 in which the questions comprise a quiz.

47. The method of claim 45 in which the questions comprise a survey.

48. The method of claim 43 in which
the information about attendees includes an identification of a first attendee that a second attendee should meet, and
adjusting the schedule includes assigning the first attendee to a session to which the second attendee is assigned.

49. The method of claim 43 also comprising
communicating the adjustments to a leader of a session.

50. The method of claim 43 also comprising
receiving the information about attendees after a session, and
adjusting the schedule before a subsequent session.

51. The method of claim 43 in which the information about attendees includes information about a meeting desired by an attendee,
adjusting the schedule includes adjusting the schedule to include the meeting, and
communicating the adjustments includes communicating the adjustment to the device assigned to the user requesting the meeting, and
communicating the adjustment to a device assigned to another user with whom the meeting is desired.

52. A method comprising
defining a set of items to be evaluated by participants at an event,
communicating subsets of the items to mobile wireless devices associated with the participants at the event, each item being communicated to at least one of the devices,
enabling each user to use his device to evaluate the items in the subset communicated the user's device, and
combining the evaluations to evaluate all the items in the set.

53. The method of claim 52 also comprising
communicating the combined evaluations to the mobile wireless devices,
enabling each user to use his device to evaluate the combination of the evaluations, and
updating the combined evaluations based on the second evaluating.

54. A method comprising
receiving first information about an attendee at an event that has been provided directly by the attendee and second information about the attendee that has been collected by a mobile wireless device assigned to the attendee with respect to the event, and
based on the information,
determining that the person is a potential customer.

55. The method of claim 54 in which the second information includes one or more of attendance at sessions, which other devices the attendee's device has communicated with, which vendors the attendee's device has communicated with, and answers the attendee has provided to questions communicated to his device.

56. The method of claim 54 also comprising receiving third information including correlations between the first or second information and similar information for other attendees.

57. A system comprising
a wireless network installed at a venue, and
mobile wireless devices to receive information over the network, the information being divided into categories,
in which a category of information to be received by a first device is different from a category of information to be received by a second device, and depends on a categorization of attendees at the venue to which the devices are to be assigned.

58. The system of claim 57 in which the categories include
information about the current status of an event,
information about customer relationships,
information describing attendees at the venue a user of a device should meet,
requests for a user of a device to meet with another attendee,
schedule information,
information from sources external to the network, and
information from sources internal to the network.
